(19) United States
(12) Patent Application Publication
(10) Pub. No.: US 2011/0265737 A1
(43) Pub. Date: Nov. 3, 2011

(54) METHODS AND DEVICES FOR FUEL REFORMATION

(76) Inventor: Robert Ryon, Colorado Springs, CO (US)

(21) Appl. No.: 13/057,596

(22) PCT Filed: Aug. 4, 2009
(86) PCT No.: PCT/US2009/052661

§ 371 Date: Jul. 25, 2011

Related U.S. Application Data
(60) Provisional application No. 61/086,062, filed on Aug. 4, 2008.

(51) Int. Cl. F02B 43/00

(52) U.S. Cl. 123/3

(57) ABSTRACT

Disclosed are methods and systems for reforming fuels by subjecting them to ultrasonic energy. Such methods and systems can be conducted and carried on-board vehicles powered by combustion engines to enhance fuel efficiency and/or modify exhaust emissions.

### REFERENCE TO RELATED APPLICATION

The present application claims the benefit of priority of U.S. Patent Application Ser. No. 61/086,062 filed Aug. 4, 2008, which is hereby incorporated by reference in its entirety.

### BACKGROUND

The present invention relates generally to the field of combustion engines. More particularity, in certain aspects the present invention is directed to devices and methods for reforming a fuel so as to improve the operating efficiency of a combustion engine operating upon the fuel.

As further background, a variety of additives and devices have been developed in attempts to modify fuels and thereby improve the efficiency of operation of combustion engines operating upon the fuels. In one area of endeavor, such additives and devices have been suggested to improve the efficiency of combustion engine-powered vehicles, with the efficiency measured in miles traveled per gallon of fuel consumed. For example, chemicals have been developed as additives to the fuel tank for this purpose. Additional examples include specialized fuel injectors to improve the atomization of fuels for feed to combustion chambers. Aside from the obvious advantages related to cost savings from increased gas mileage, another potential advantage of increasing importance is an accompanying reduction of pollutants emitted from an engine.

In view of the prior art in the area, needs remain for improved and/or alternative fuel conditioning methods and devices, that are preferably low cost, compact, and easy to install. Embodiments of the present invention are addressed to some or all of these needs.

### SUMMARY

In certain of its aspects, the present invention is related to devices and methods that successfully achieve a reformation of fuel, such as gasoline or diesel fuel, under the action of ultrasonic energy. The reformed fuel can be combusted in a combustion engine so as to provide enhanced fuel efficiency as compared to the corresponding unreformed fuel. Accordingly, in one embodiment of the present invention, provided is a method for enhancing the operation of a combustion engine. The method includes providing a base liquid hydrocarbon fuel for combustion in the engine, and subjecting the base liquid hydrocarbon fuel to ultrasonic energy at an intensity sufficient to break molecules of the fuel to create a reformed hydrocarbon fuel. The reformed fuel is then combusted in the engine. The fuel can, as examples, be gasoline or diesel fuel. During the reforming process, the fuel can be maintained in a substantially plug flow, and/or the action of the ultrasonic energy can create cavitation bubbles in the base liquid hydrocarbon fuel. The combustion engine can be on-board a vehicle, and the providing, subjecting and combusting steps can all occur on-board the vehicle so as to power the vehicle.

In another embodiment, the present invention provides an apparatus for reforming a liquid hydrocarbon fuel. The apparatus includes a fuel flow path, and a source of ultrasonic energy operable to deliver ultrasound to reform the fuel in the flow path. In certain embodiments, the apparatus is configured to maintain the fuel in a substantially non-atomized state as it passes through the flow path, such as a substantially plug flow. In addition or alternatively, the apparatus can be operable wherein the action of the ultrasonic energy is effective to split molecules of the fuel, for example under conditions in which the ultrasonic energy creates cavitation bubbles within the flowing fuel, which thereafter energetically collapse.

In additional embodiments, the present invention provides apparatuses that include a combustion engine, and at least one ultrasonic apparatus for reforming a liquid hydrocarbon fuel for the engine, as discussed herein.

In further embodiments, the present invention provides vehicles powered by combustion engines, wherein the vehicles include at least one on-board ultrasonic apparatus for reforming a liquid hydrocarbon fuel upon which the engine operates, as discussed herein.

In another embodiment, the present invention provides a method for reforming gasoline or diesel fuel comprising subjecting gasoline or diesel fuel to the action of ultrasonic energy at an intensity sufficient to reform the fuel by splitting molecules of the fuel.

In another embodiment, the present invention provides a method for reforming gasoline or diesel fuel, comprising subjecting gasoline or diesel fuel to ultrasonic energy, wherein the ultrasonic energy is at an intensity of 1 to 10 Megawatts per square meter.

In another embodiment, the present invention provides a method for reforming liquid hydrocarbon fuel. The method includes passing a hydrocarbon fuel through a first flow path, e.g. provided by a fuel line, and feeding the hydrocarbon fuel from the first flow path into a reforming chamber wherein the hydrocarbon fuel is subjected to ultrasonic energy, thereby creating a reformed fuel. The reformed fuel is thereafter fed from the reforming chamber through a second flow path, for example through a second fuel line. In certain embodiments, at some point after passing through the second flow path, the reformed fuel can be introduced into a combustion chamber of a combustion engine associated with the second flow path.

In another embodiment, the present invention provides a method for reforming liquid hydrocarbon fuel that includes subjecting a liquid hydrocarbon fuel to ultrasonic energy while maintaining the liquid hydrocarbon fuel in a plug flow condition.

In another embodiment, the invention provides a method for reforming a liquid hydrocarbon fuel that comprises subjecting the fuel to the action of ultrasonic energy under conditions effective to form and collapse cavitation bubbles in gasoline or diesel fuel. The conditions of reformation can be effective to split molecules of the fuel.

Additional embodiments, as well as features and advantages thereof, will be apparent to those skilled in the art from the descriptions herein.

### BRIEF DESCRIPTION OF TEE FIGURES

FIG. 1 provides a diagram of one embodiment of a fuel reforming system of the invention installed on-board a vehicle.

FIG. 2 provides a diagram of additional embodiments of fuel reforming systems of the invention.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

As disclosed above, aspects of the present invention relate to devices and methods that reform fuels such as gasoline or diesel fuels under the action of ultrasonic energy. In certain inventive variants, the fuels are reformed on-board a vehicle in which the fuels will be combusted to power the vehicle.

Aspects of the present invention relate to reformation of hydrocarbon fuels using ultrasonic energy. The fuels are adapted for combustion in an internal combustion engine. The fuel can be gasoline (also known as “petrol”), which is predominately a mixture of hydrocarbons, although it may also contain significant quantities of ethanol and/or small quantities of additives such as anti-knock agents to increase its octane rating. The hydrocarbons are a mixture of n-paraffins, naphthenes, olefins, and aromatics. The aromatics consist predominately of a mixture of benzene, toluene, and xylenes. Gasoline will typically have an octane rating of about 85 to about 95. The fuel may also be diesel fuel and thus adapted for combustion in a diesel engine. When produced from petroleum, diesel fuel is usually that fraction of crude oil that distills after kerosene. Diesel fuel contains a mixture of hydrocarbons, and typically has a distillation range of 390° F. to 715° F. Diesel fuel quality is commonly defined by the cetane number, which typically falls in the range of about 30 to about 60. Fuels used in the present invention may be petroleum derived, or may be partially or wholly derived from other sources such as plants, e.g. in the case of bio-diesel fuel. The fuel may also be “Flex Fuel”, which is a blend of gasoline and ethanol at various ratios, or “E85”, which is a blend of 15% gasoline and 85% ethanol. Other fuels adapted for combustion in internal combustion engines, particularly those used in vehicles, can also be used within aspects of the present invention.

In certain aspects of the invention, the combustion engine fuel is subjected to ultrasonic energy to reform the fuel and the fuel is then combusted in the combustion engine without any separation of fractions of the fuel occurring between the ultrasonic reforming and the combustion (i.e. the reformed fuel is combusted as a whole). Currently, technologies for generation of ultrasonic energy include piezoelectric or magnetostrictive devices. These devices are sometimes referred to as “sonicators”. Piezoelectric ultrasonic generators are more common in use today and are preferred. A piezoelectric ultrasound generator can include a piezoelectric crystal capable of converting electrical energy to mechanical vibration (termed a “transducer”), and an associated ultrasonic probe or “horn” through which the vibration is transferred and amplified. In preferred forms, the ultrasound generating device will be effective to produce ultrasound at an intensity of at least 1 Megawatt per square meter (MW/m²), typically in the range of about 1 to about 10 (MW/m²), to produce a liquid shearing pressure on the order of about 1 to 2 (MPa). The frequency of the applied ultrasound can be in the range of about 10 kilohertz (kHz) to 200 kHz, more typically in the range of about 20 kHz to about 40 kHz. Additionally, the frequency of the ultrasound energy and/or the intensity of the ultrasound energy can be varied in multiple-stage treatments in which the fuel is subjected multiple times to varied ultrasonic energy. The amplitude of motion of the tip of the ultrasonic probe can be in the range of about 20 microns to about 200 microns, more typically in the range of about 80 to about 120 microns. In certain embodiments, the ultrasound frequency can be about 20 kHz and the amplitude of motion of the tip of the ultrasonic probe can be in the range of about 80 microns to about 120 microns. In certain other embodiments, the ultrasound frequency can be about 40 kHz and the amplitude of motion of the tip of the ultrasonic probe can be in the range of about 40 to about 60 microns. Suitable commercial sonicators for carrying out aspects of the invention include, for example, sonicators available for Misonix, Inc. such as the Sonicator 3000 or the Sonicator 4000, available from Misonix, Inc. (Farmingdale, N.Y., USA). When necessary, because many commercial sonicators operate on alternating current, an electric power supply including a device that converts direct current to alternating current, such as an inverter, can be used to convert direct current to alternating current in the implementation forms of the present invention in vehicles that operate on DC electricity. Modified sonicators that operate on direct current can be employed.

In methods and systems of the invention, the ultrasonic probe can be in direct contact with the fuel to be treated, or can be in contact or associated with other elements, such as tube or chamber walls, that will ultimately impart the ultrasonic energy to the fuel. As a result of the application of the ultrasonic energy, the fuel is reformed in such a way that the fuel efficiency of the internal combustion engine is increased and/or the exhaust emissions of the internal combustion engine are modified, for example, to reduce the emitted levels of one or more of hydrocarbon, carbon monoxide, or methane. Typically, the applied ultrasonic energy causes the formation of cavitation bubbles within the liquid fuel that energetically collapse. This energetic collapse can cause or be accompanied by the breakage of covalent bonds of molecular components of the fuel, which in turn can reduce the average molecule size in the fuel and/or generate a differing molecular composition of the fuel that leads to the enhanced fuel efficiency or lower emissions. In certain embodiments, the fuel reforming achieved can enhance the fuel efficiency of the combustion engine by at least about 5%, more preferably by at least 10%, as measured by the amount of work performed by the engine for a given volume of fuel consumed. In the case of a vehicle powered by the combustion engine, this increase in fuel efficiency of at least about 5%, more preferably at least about 10%, can be measured in terms of the distance traveled by the vehicle per unit volume of fuel consumed, e.g. the number of miles traveled per US gallon of fuel consumed, or the number of kilometers traveled per liter of fuel consumed.

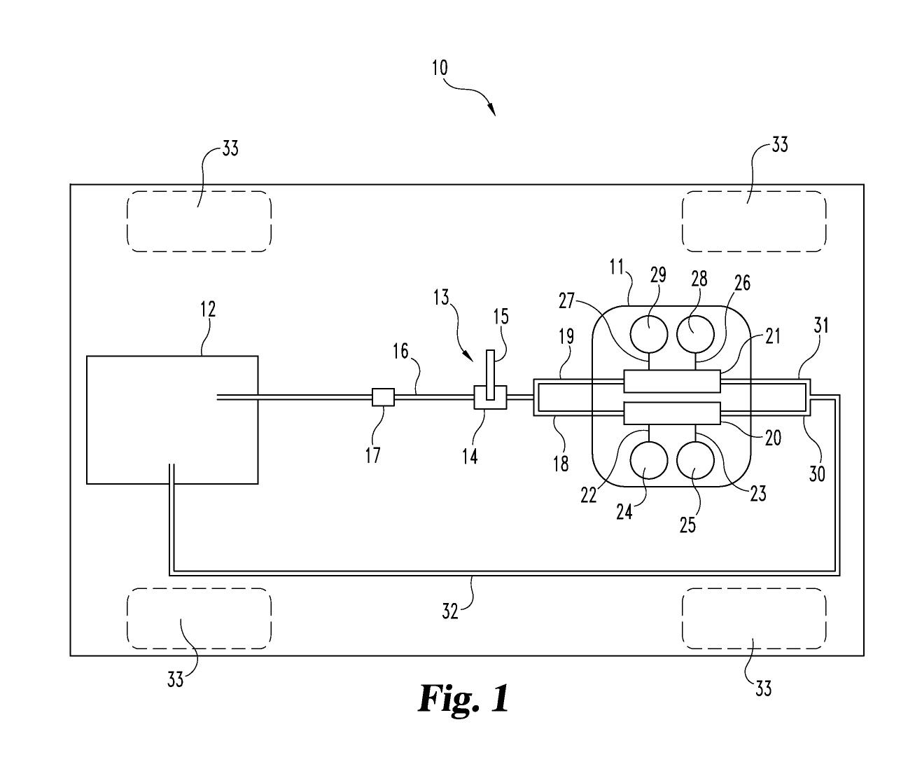

With reference now to FIG. 1, shown is a vehicle 10 having a system of the invention mounted on board the vehicle. Vehicle 10 includes a combustion engine 11 and a source of fuel such as fuel tank 12 from which fuel is fed to the combustion engine 11. This feed of fuel is facilitated by fuel line 16 having an ultrasonic treatment apparatus 13 installed therein. Ultrasonic treatment apparatus 13 includes a chamber defining a confinement space for receiving fuel 14, such as a flowcell, and a sonicator having its probe tip positioned within the chamber 14. In the illustrated embodiment, a fuel filter 17 is installed upstream of the ultrasonic treatment apparatus 13 in the fuel line. Further, in the disclosed embodiment, the treated fuel outflow from the treatment apparatus 13 is split into separate fuel paths defined by separate fuel lines 18 and 19, which feed fuel rails 20 and 21, respectively. Fuel rail 20 feeds fuel to injectors 22 and 23 which in turn inject fuel into combustion chambers 24 and 25 of engine 11. Fuel rail 21 feeds fuel to injectors 26 and 27 which in turn inject fuel into combustion chambers 28 and 29 of combustion engine 11. Unused fuel exiting fuel rails 20 and 21 through flow paths 30 and 31 is returned to fuel tank 12 via flow path 32. These and other fuel flow paths of systems of the invention can be provided by appropriate fuel lines or any other structure suitable for conveying the fuel.

In use, during the operation of combustion engine 11, fuel fed from tank 12 is reformed by ultrasonic treatment apparatus 13 as described herein, and is thereafter combusted in the operation of engine 11. Engine 11 in turn drives the rotation of one or more of the wheels 33 of the vehicle. As noted above, the action of reforming the fuel can enhance the fuel efficiency of the engine 11, e.g. as can be measured by an increase in miles traveled per gallon of fuel consumed in the wheeled vehicle 10, and/or can reduce the emission of undesirable components in the exhaust gas generated by the operation of engine 11. In the system illustrated in FIG. 1, because the fuel rails 20 and 21 do not deliver all passing fuel to their respective injectors, a portion of the fuel that has been treated by ultrasonic treatment apparatus 13 is returned to tank 12. This results in the recycle and effective re-treatment of the fuel over time as it is cycled repeatedly through device 14 and then fuel rails 20 and 21 and back into tank 12. This in turn results in an increasing level of reformation of the fuel in tank 12 as the vehicle 10 is operated on a given tank of fuel. It will be understood, however, that this is not necessary to the broader aspects of the present invention, and that all of the fuel treated by ultrasonic treatment apparatus 13 can be combusted in engine 11 without recycle to tank 12. This may be accomplished, for example, by locating multiple ultrasonic treatment apparatuses in the system downstream of fuel rails 20 and 21, with one such apparatus provided for each injector 22, 23, 26, and 27, or with the ultrasonic treatment device built into the injectors 22, 23, 26 and 27. In this manner, only that fuel which is set for immediate combustion will be reformed. Further, one or more ultrasonic treatment devices can be located at any other suitable location within the fuel path. Illustratively, an ultrasonic treatment device such as apparatus 13 could be located in return line 32 to tank 12, and still result in the reformation of fuel ultimately combusted in engine 11. Additionally or alternatively, an ultrasonic treatment device such as apparatus 13 can be located in fuel tank 12 or in a closed liquid flow loop with an input and output fluidly communicating with fuel tank 12 so as to treat fuel of the tank 12 so as to reform it prior to combustion in the engine. Still further, in additional embodiments of the invention, the tip of the “horn” or other tip of the sonicator need not be in direct contact with the fuel, so long as the ultrasound energy originating from the tip is transmitted to the fuel so as to reform the fuel as described herein. Thus, in certain forms, the tip of the sonicator can be isolated from the fuel, e.g. positioned outside the physical components such as fuel lines or other chambers carrying the fuel, but connected to, abutting, or otherwise associated with those physical components such that ultrasound delivered by the sonicator is transmitted to the fuel (e.g. through the walls of the chambers) so as to cause the fuel reformation. These and other variations will be apparent to those of ordinary skilled in the art from these descriptions herein.

The one or more ultrasonic treatment devices can be provided at any suitable position on the vehicle 10. In preferred embodiments, the ultrasonic treatment device(s) is/are located in an engine compartment of the vehicle, typically located under a front or rear hood providing access to the engine compartment.

Combustion-engine powered vehicles in which the present invention may be employed include, as examples, marine vehicles such as boats, including passenger and cargo boats, land vehicles (typically wheeled vehicles) including as cars, vans, trucks and trains, and airborne vehicles including as examples jet-powered planes or propeller-driven planes. Stationary devices employing combustion engines in which the present invention may be employed include, as examples, generators and motors.

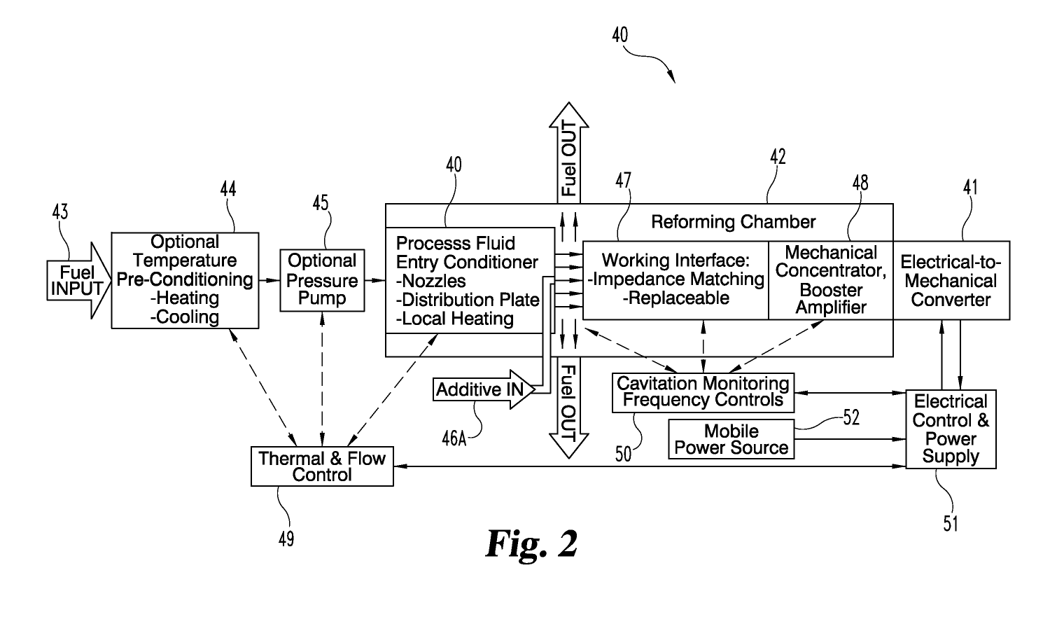

With reference now to FIG. 2, a number of additional system options will be described. System 40 includes an ultrasonic energy generator 41, such as a sonicator, associated with a chamber 42 for reforming fuel. A fuel input 43 is provided into the reforming chamber 42. Prior to entry into the chamber 42, a number of pre-conditioning operations may be conducted. These may include, for example, heating or cooling the fuel or regulating the flow of the fuel, e.g. accelerating the fuel by passage through one nozzle or a plurality of nozzles, e.g. from 2 to 20 nozzles that may be defined in a fluid distributor plate interposed in the fuel path. Such nozzle(s) can be configured to accelerate the fuel for contact with the horn or other tip of the ultrasonic treatment device.

Illustratively, in certain instances, it may be desired to decrease the viscosity of the fuel, for example, in the case of diesel fuel. In those situations, system component 44 can be used to heat the fuel. Similarly, it may desirable to increase the pressure of the fuel entering chamber 42. In those circumstances, a pressure pump component 45 may be provided in the system. As well, the condition of the fuel upon entering the reforming chamber 42 may be regulated by a system component 46, which may for example be a suitable nozzle, fluid distribution plate, or heater to locally heat the fuel. At system component 46A, or at other points in the fuel feed, one or more gases, for example hydrogen, or other additives, for example catalyst(s) to enhance the reforming process e.g. by enhancing the breakage of covalent bonds of molecular components of the fuel, may also be added to the fuel.

In terms of regulation of the ultrasonic generation, a number of controls may be undertaken at system component 47 including, for example, optimally matching the action of the probe or other ultrasonic element to the medium, impedance matching, or other functions. Further, the reforming chamber and/or the ultrasonic probe or other member may have adaptations for a mechanical concentrator, booster, or amplifier, as denoted at system component 48. System components 49 and 50 are controllers, such as computer controllers, that regulate the disclosed options for processing the fuel input and/or the ultrasonic treatment apparatus. In the case of vehicle installations, the controller can be an on-board computer of the vehicle. An electronic control and power supply 51 can feed to both the ultrasonic generator 41 and the controllers 49 and 50. This control and power supply 51 can be powered by a mobile electrical power source 52, such as the DC power system of a vehicle.

Systems of the invention can be retrofitted or originally manufactured into a variety of vehicles and other implements that are powered by combustion engines, including for example cars, trucks, marine vehicles, semi-trailers, trains, and generators, or others mentioned herein.

For the purpose of promoting a further understanding of aspects of the present invention, as well as features and advantages thereof, the following specific examples are provided. It will be understood that these Examples are illustrative, and not limiting, of the invention.

### Example 1

An 800B flowcell equipped with a Sonicator 3000 (both from Misonix, Inc., Farmingdale, N.Y., USA) was mounted inline on the fuel line coming from the fuel tank of a 1999 Ford Expedition with a 5.4 liter eight cylinder engine (2-wheel drive), having a factory estimated city performance of 13 miles per gallon (US) and a factory estimated highway performance of 18 miles per gallon when new. Other than the flowcell/sonicator apparatus, the vehicle and engine were stock. A bypass valve and plumbing were also installed that could divert the fuel around the flowcell for comparative testing. The flowcell/sonicator apparatus was placed in a protective housing and mounted to the firewall in the engine compartment of the vehicle. The two exit lines from the flow cell were connected to the input fuel rails of the vehicle. The return lines from the fuel rails routed the unused fuel back to the fuel tank in standard fashion. The instrument power supply and controller unit for the sonicator were mounted inside the vehicle driver compartment with its control panel accessible to the driver for monitoring operation. The sonicator operated at a frequency of about 25 kHz and was operated at a setting of 8 to 9 on the control dial (power output of about 180 watts). The probe movement was about 80 to 110 microns. The vehicle was tested for miles-per-gallon and emissions by Environmental Testing Corporation (Aurora, Colo., USA), an EPA-certified facility. The dynamometric tests simulated both city and highway driving. The results for city driving were 14.92 MPG and for highway driving were 22.26 MPG, constituting an increase of 14.8% in city driving and 23.7% in highway driving as compared to the factory estimates.

### Example 2

The 1999 Ford Expedition equipped as in Example 1 was subjected to road testing. Under highway driving conditions at approximately 55 miles per hour, the sonicator apparatus was turned on and off for various intervals under relatively equivalent driving conditions. In these tests, operation of the sonicator apparatus provided approximately a 20% increase in fuel efficiency.

What is claimed is:

1. A method for enhancing the operation of a combustion engine, comprising:
providing a base liquid hydrocarbon fuel for combustion in the engine; and
subjecting said base liquid hydrocarbon fuel to ultrasonic energy at an intensity sufficient to split molecules of the fuel to create a reformed hydrocarbon fuel; and
combusting said reformed liquid hydrocarbon fuel in the engine.

2. The method of claim 1, wherein said base liquid hydrocarbon fuel is gasoline.

3. The method of claim 1, wherein said base liquid hydrocarbon fuel is diesel fuel.

4. The method of claim 1, wherein said intensity is within the range of about 1 to about 10 Megawatts per square meter.

5. The method of claim 1, wherein during said subjecting, said base liquid hydrocarbon fuel is maintained in a substantially plug flow.

6. The method of claim 1, wherein said subjecting creates cavitation bubbles in said base liquid hydrocarbon fuel.

7. The method of claim 1, wherein said combustion engine is on-board a vehicle, and wherein said providing, subjecting and combusting are all conducted on-board said vehicle so as to power said vehicle.

8. The method of claim 1, wherein said providing a base liquid hydrocarbon fuel includes providing a plurality of fuel flow paths into a respective plurality of combustion chambers of said engine, and wherein said subjecting comprises subjecting fuel while traveling in each of said flow paths to said ultrasonic energy.

9. The method of claim 8, comprising providing a plurality of sonicators, with each said flow path receiving said ultrasonic energy from a respective one of said sonicators.

10. The method of claim 1, wherein said engine powers a vehicle or an electrical generator.

11. The method of claim 10, wherein said engine powers a vehicle, and wherein said vehicle is a marine vehicle, a land vehicle, or an airborne vehicle.

12. The method of claim 1, wherein said subjecting said base liquid hydrocarbon fuel to ultrasonic energy comprises flowing said fuel in contact with the tip of a sonicator device delivering said ultrasonic energy.

13. The method of claim 12, wherein said flowing comprises accelerating said fuel by passage through at least one nozzle.

14. A method for reforming gasoline or diesel fuel, comprising:
subjecting gasoline or diesel fuel to ultrasonic energy at an intensity sufficient to reform the fuel by splitting molecules of the fuel.

15. A method for reforming gasoline or diesel fuel, comprising:
subjecting gasoline or diesel fuel to the action of ultrasonic energy at an intensity of 1 to 10 Megawatts per square meter.

16. A method for reforming liquid hydrocarbon fuel, comprising:
passing a hydrocarbon fuel through a first fuel line;
feeding the hydrocarbon fuel from the first fuel line into an ultrasonic fuel reformer wherein the hydrocarbon fuel is subjected to ultrasonic energy, thereby creating a reformed fuel; and
feeding the reformed fuel from the ultrasonic fuel reformer into a second fuel line.

17. A method for reforming liquid hydrocarbon fuel, comprising:
subjecting a liquid hydrocarbon fuel to ultrasound while maintaining the liquid hydrocarbon fuel in a non-atomized condition.

18. A method for reforming a liquid hydrocarbon fuel, comprising:
subjecting a liquid hydrocarbon fuel to ultrasonic energy under conditions effective to form and collapse cavitation bubbles in the fuel.

19. An apparatus for reforming a liquid hydrocarbon fuel, comprising:
a flow path for passage of the liquid hydrocarbon fuel in bulk liquid condition; and
an source of ultrasonic energy operable to deliver ultrasonic energy to fuel in said flow path at an intensity effective to reform the liquid hydrocarbon fuel during said passage.

20. A combination, comprising:
an apparatus of claim 19; and
a combustion engine having a combustion chamber fluidly coupled to said flow path.

21. A vehicle comprising a combination in accordance with claim 20.
